(19) United States
(12) Patent Application Publication
(10) Pub. No.: US 2006/0226314 A1
(43) Pub. Date: Oct. 12, 2006

(54) clamps

(75) Inventors: Joseph Claude Raymond Dube, Ganderkesee (DE); Armin Brosch, Oldenburg (DE); Bernd Lau, Berlin (DE)

Correspondence Address: NIXON PEABODY LLP - PATENT GROUP, CLINTON SQUARE, P.O. BOX 31051, ROCHESTER, NY, 14603-1051, US

(73) Assignee: Severfield-Rowen PLC, North Yorkshire (GB)

(21) Appl. No.: 11/325,726

(22) Filed: Jan. 5, 2006

(30) Foreign Application Priority Data
Jan. 13, 2005 (GB) 0500619.2

(51) Int. Cl. G09F 7/18

(52) U.S. Cl. 248/228.1

(57) ABSTRACT

An improved clamp is disclosed. The clamp comprises a location surface adapted to lie against an external surface of the object to be engaged, and first and second clamp members adapted for movement relative to one another. The first and second clamp members are adapted to be brought into engagement with the object, such that the object or part of the object is captivated between the location surface and the first and second clamp members.

This application claims the benefit of United Kingdom Patent Application No. 0500619.2, filed Jan. 13, 2005, which is hereby incorporated by reference in its entirety.

### FIELD OF THE INVENTION

This invention relates to clamps, and in particular to clamps for fixing construction apparatus to one or more beams of a structure.

### BACKGROUND

Modern buildings, whether commercial, office or residential units, are often constructed by first forming a building framework on suitable foundations, and then forming the floors and walls of the building within and about the building framework. The building framework generally comprises a plurality of vertically orientated steel columns to which horizontally orientated steel beams or girders are attached to form a floor-supporting framework for each floor of the building.

Once the foundations have been formed and the vertical columns erected, the floor-supporting frameworks are constructed about, and fixed to, the vertical columns. Beams are raised to the level of a particular floor in a horizontal orientation and fixed by construction workers to appropriate vertical columns or other horizontal beams until the floor-supporting framework for that floor is completed. Once a floor-supporting framework has been constructed, a floor is formed about, or on, the supporting framework. For example, concrete is typically cast about each floor-supporting framework, thereby forming the floors of the building.

The horizontal beams are typically raised to their intended fixing site using a tower crane or the like. The construction workers who fix the horizontal beams to the building framework are conventionally raised to the fixing site using a Mobile Elevated Work Platform (MEWP) that is situated on the ground. However, a MEWP situated on the ground is only suitable for constructing the first few floors of a building due to its limited vertical and horizontal range, and is therefore unsuitable for the construction of tall buildings and for use at construction sites having limited space or unsuitable ground conditions. In this case, construction workers are either transported to the fixing site on a work platform carried by a crane, or a MEWP is lifted onto the highest completed floor by a crane and then used to transport construction workers to fixing sites within range of the MEWP.

The method of lifting a MEWP onto the highest completed floor using a crane, and then using the MEWP to transport construction workers to fixing sites within range of the MEWP, suffers from numerous disadvantages. Such disadvantages include the need to install floors before the building framework is completed in order to support the MEWP. In particular, the loading of a concrete floor should not occur until the concrete has cured to about 75% of its full loading capacity, which generally takes at least five days following installation, and concrete floors typically need at least twenty-eight days to cure fully. In addition, there is an increased risk of an accident occurring when a MEWP is supported on the floor of a partially constructed building rather than the ground. In particular, the drive system of a MEWP is generally not disabled at a construction site, and hence an inexperienced operator could drive the MEWP over the edge of the floor because guardrails are generally designed to prevent construction workers, rather than heavy machines, from falling over the edge.

The method of transporting construction personnel to the fixing site on a work platform carried by a crane also suffers from disadvantages, which include the increased risk of an accident occurring when construction workers are left, secured by a harness to the building framework, at the fixing site whilst the crane raises a beam to the fixing site.

Whatever method is used to bring the construction workers into position, it is commonly the case that the workers need to access open steelwork. This may involve straddling the steelwork, climbing ladders lashed to the steelwork and the workers securing themselves to the steelwork using lanyards and safety harnesses. Considerable hazards are involved in such operations.

In general, the inefficiency and/or inconvenience of conventional methods used in the erection of structural frameworks for buildings may increase the likelihood of non-compliance with safety regulations and proper working procedures, with an increased risk of harm to the construction personnel.

There is therefore a need for construction apparatus including means for releasably fixing the apparatus to one or more beams of a structure.

### SUMMARY

There has now been devised an improved clamp, and apparatus incorporating the improved clamp, which overcome or substantially mitigate the above-mentioned and/or other disadvantages associated with the prior art.

According to a first aspect of the invention, there is provided a clamp for engagement with an object, the clamp comprising a location surface adapted to lie against an external surface of the object, and first and second clamp members adapted for movement relative to one another, wherein the first and second clamp members are adapted to be brought into engagement with the object, such that the object or part of the object is captivated, in use, between the location surface and the first and second clamp members.

The clamp according to the invention is advantageous principally because the location surface facilitates location of the clamp relative to the object to be clamped, and the relative movement of the first and second clamp members enable a wide range of differently sized objects to be securely engaged by the clamp.

The clamp according to the invention is particularly advantageous for use in the engagement of a beam that forms part of a building structure, and hence the clamp is most preferably adapted for engagement with a beam. The clamp may be suitable for engagement with beams having a range of different cross-sectional shapes, such as circular, rectangular or hexagonal cross-sections. However, the clamp is preferably adapted for engagement with an I-section beam comprising a pair of flanges joined by a connecting web. In this case, the location surface is preferably adapted to lie against an outer face of one of the two flanges, and the clamp members are preferably adapted to engage an inner face of that flange on either side of the connecting web, such that the flange is captivated, in use, between the location surface and the first and second clamp members.

The clamp preferably comprises a housing to which the first and second clamp members are preferably mounted. The location surface is preferably defined by the housing, but may be defined by a separate location member. In addition, the housing may define one of the first and second clamp members.

Most preferably, the clamp includes a depression within which the object or part of the object is received, in use, as the location surface is brought alongside an external surface of the object. This depression may be defined by the housing alone, or together with one or both of the clamp members. Most preferably, the depression is defined substantially by the housing, and is tapered so as to aid location of the flange alongside the location surface.

One or both of the first and second clamp members may be rotatably mounted relative to the location surface, such that the clamp members may be brought into engagement with the object once the location surface has been located alongside an external surface of the object. In presently preferred embodiments, however, the first clamp member is mounted for linear movement relative to the second clamp member, and also preferably relative to the housing and the location surface. Most preferably, the first clamp member is mounted for linear movement in the plane of the location surface. This linear movement is preferably actuated by a hydraulic ram or the like. This arrangement enables the clamp to engage beams having a greater range of cross-sectional shapes and sizes.

In this case, the first clamp member and/or the second clamp member preferably has an operable face that is inclined relative to the operable face of the location surface, such that the operable face of the first clamp member or the second clamp member and the operable face of the location surface subtend an acute angle. In addition or alternatively, the first clamp member and/or the second clamp member may be rotatable relative to the location surface so that the clamp member may be rotated into engagement with an external surface of the object. This rotation may be effected by a suitable drive mechanism that is controlled by a user, but most preferably this rotation is effected by the object impinging upon the clamp member during use. In presently preferred embodiments, the first clamp member has an inclined operable face, and the second clamp member is rotatable relative to the location surface, as described above.

The clamp according to the invention is particularly advantageous for fixing construction apparatus to one or more beams and/or columns of a structure. Hence, according to a further aspect of the invention, there is provided construction apparatus comprising one or more clamps as described above. The structure to which the construction apparatus is fixed may be a completed structure or, more commonly, a structure that is under construction. In particular, the apparatus may be attached using the clamps to the beams and/or columns of a steel framework about which a building is constructed.

The apparatus preferably comprises a base unit including a plurality of clamps for fixing the base unit to a structure such that the base unit is in an elevated position relative to the ground. Preferably, one or more of said clamps, and most preferably all of said clamps, are movably mounted relative to the base unit. This enables the base unit to be fixed readily to a range of different structures.

Preferably, the apparatus according to the invention comprises three or more clamps for fixing the base unit at three or more points to the structure under construction, the three or more clamps being movably mounted relative to the base unit. Most preferably, the apparatus according to the invention comprises four clamps for fixing the base unit at four points to the structure under construction, the four clamps being movably mounted relative to the base unit.

The clamps of the apparatus are preferably adapted to engage one or more beams or the like of a structure. These beams will generally take the form of I-section beams that are conventionally formed from steel. However, the clamps may be adapted to engage different beam profiles, such as beams having circular, rectangular or hexagonal cross-sectional shapes. Most preferably, the clamps of the apparatus are adapted to engage a pair of horizontal beams that are orientated parallel to each other. However, the clamps may be adapted to engage other arrangements of beams, such as arrangements comprising non-parallel horizontal beams and/or vertical beams.

Each clamp is preferably attached to a leg that extends from the base unit. Each clamp is preferably movable relative to the base unit, and such movement is preferably brought about by movement of the leg relative to the base unit. In particular, each leg is preferably movable relative to the base unit and/or adjustable in length such that the length of that part of the leg that projects beyond the base unit is alterable. Most preferably, the apparatus comprises four legs with a clamp attached to the distal end of each leg.

Each leg may be rotatably mounted to the base unit. In this case, each leg is preferably also telescopically extendible and retractable. In a presently preferred embodiment, however, each leg is slidably mounted within a housing that is fixed relative to the base unit, such that a clamp at one end of each leg may be extended and retracted relative to the base unit by movement of the leg relative to the housing. In this case, the apparatus preferably comprises four legs that are arranged parallel to one another.

Two or more of the clamps, and hence their associated legs, may be mechanically connected so as to facilitate coordinated movement of the clamps. Alternatively, coordinated movement of the legs and clamps may be achieved by means of a microprocessor and suitable sensors. In particular, since structures generally include pairs of parallel beams, the apparatus is preferably arranged such that the clamps are always arranged along two parallel lines.

The operation of the clamps is preferably controllable by a construction worker accommodated by the apparatus. In addition, the movement of the clamps relative to the base unit is preferably controllable by a construction worker accommodated by the apparatus. In particular, the apparatus preferably includes a control panel that enables a construction worker to control said operation and/or movement of the clamps, and hence also any legs supporting the clamps. The control panel preferably includes, or is in communication with, a suitable control device, such as a microprocessor. Most preferably, the control panel is connected to the microprocessor and/or the clamps such that the control panel is movable by the construction worker relative to the apparatus. In particular, the control panel is preferably connected to the microprocessor and/or the clamps by means of a flexible cable or a wireless link. Preferably, each clamp and leg is operated and/or moved using a hydraulic or electro-mechanical transmission system.

Each clamp may be rotatable relative to the leg on which it is mounted. In particular, the orientation of each clamp relative to its corresponding leg may be determined by an appropriate drive mechanism and controllable from the control panel of the base unit. Alternatively, each clamp may be resiliently biased into a rest orientation, and rotated in use by engagement with the beam to which the clamp is to be fixed.

However, in presently preferred embodiments, each clamp is fixed to one end of a leg. In this case, the first clamp member is preferably mounted to a carriage, which is itself mounted within the leg and includes a mechanism for moving the carriage relative to the leg, such that the first clamp member may be moved along a linear path relative to the leg. In particular, the carriage is preferably slidably mounted within the leg.

Most preferably, the second clamp member has a fixed linear position relative to the leg. Hence, the first and second clamp members are preferably brought into engagement with the flange by extension of the leg until the second clamp member engages the flange, and retraction of the carriage until the first clamp member engages the flange. These movements may be effected together, or in sequence, as appropriate.

Preferred embodiments of the invention will now be described in greater detail, by way of illustration only, with reference to the accompanying drawings, in which

### BRIEF DESCRIPTION OF THE DRAWINGS

FIG. 1 is an end view of a first embodiment of a clamp according to the invention engaged with a first beam;

FIG. 2 is an end view of the first embodiment of a clamp according to the invention engaged with a second beam;

FIG. 3 is an end view of a second embodiment of a clamp according to the invention engaged with a beam;

FIG. 4 is a perspective view of a third embodiment of a clamp according to the invention engaged with a beam;

FIG. 5 is a perspective view of a fourth embodiment of a clamp according to the invention engaged with a beam;

FIG. 6 is a perspective view of a base unit of construction apparatus according to the invention including a fifth embodiment of a clamp according to the invention;

FIG. 7 is a fragmentary perspective view of the base unit;

FIG. 8 is a fragmentary side view of the base unit;

FIG. 9 is a side view of a clamp of the base unit in which the clamp is in an open configuration;

FIG. 10 is a view similar to that of FIG. 9 showing the clamp of the base unit in a first stage of engagement with a beam;

FIG. 11 is a view similar to that of FIG. 10 showing the clamp of the base unit in a second stage of engagement with a beam; and

FIG. 12 is a view similar to that of FIG. 11 showing the clamp of the base unit engaged with a beam.

### DETAILED DESCRIPTION

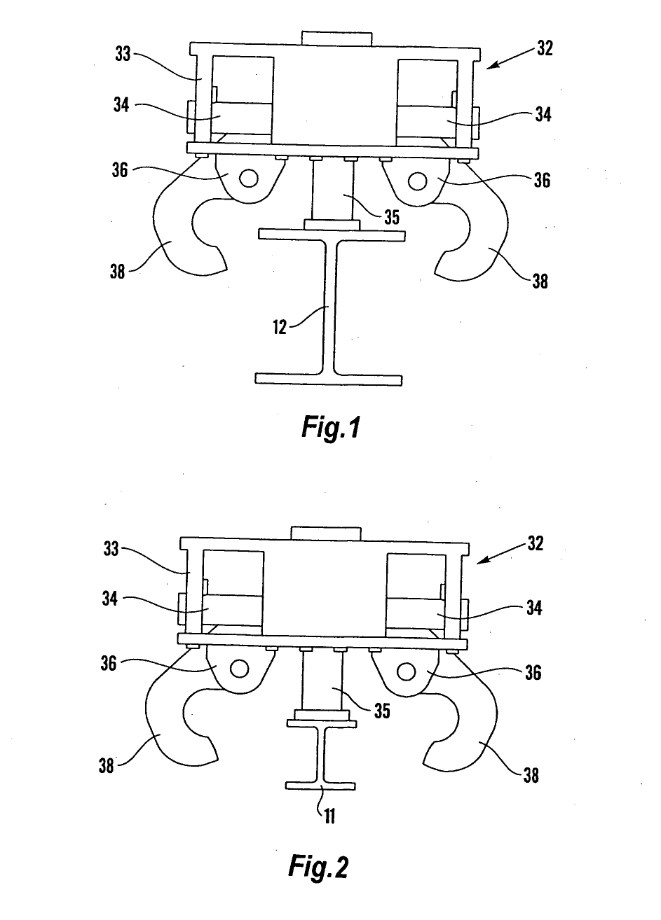

FIGS. 1 and 2 show a first embodiment of a clamp according to the invention, which is generally designated 32, positioned above a beam 11,12 before the clamp 32 has been actuated into engagement with the beam 11,12. The beam 12 shown in FIG. 1 is an I-section steel beam with a depth of 300 mm. The beam 11 shown in FIG. 2 is an I-section beam with a depth of 140 mm. Each beam 11,12 comprises horizontally-orientated upper and lower flanges that are separated by a vertically-orientated connecting web.

The clamp 32 comprises a housing 33, a pair of hydraulic rams 34, a locating member 35, and a pair of clamp arms 38. The locating member 35 is a generally cylindrical body that extends downwardly from the lower surface of the housing 33 and has a flat lower surface.

The housing 33 includes two pairs of flanges 36 that extend downwardly from its lower surface. Each clamp arm 38 is pivotally mounted between a pair of flanges 36, at a point between its ends, so that the clamp arms 38 are able to rotate relative to the housing 33. Each hydraulic ram 34 is pivotally attached at one end to a wall of the housing 33, and at the other end to the upper end of the clamp arm 38 that is situated adjacent to the opposing wall of the housing 33. Extension and retraction of the hydraulic rams 34 causes the clamp arms 38 to rotate relative to the housing 33.

Before engagement, the hydraulic rams 34 are retracted until the clamp arms 38 are positioned such that the clamp 32 can be lowered until the locating member 35 contacts the upper surface of the beam 11,12. On actuation of the clamp 32, the hydraulic rams 34 are extended, thereby rotating the clamp arms 38, until the ends of the clamp arms 38 that are remote from the hydraulic rams 34 are brought into abutment with the lower surface of the upper flange of the beam 11,12. In this way, the clamp 32 captivates the flange of the beam 11,12 between the locating member 35 and the clamp arms 38, and hence fixes the apparatus 10 to the beam 11,12. The clamp arms 38 engage a central part of the upper flange of the beam 11,12, thereby enabling the clamp 32 to captivate a range of differently sized beams 11,12.

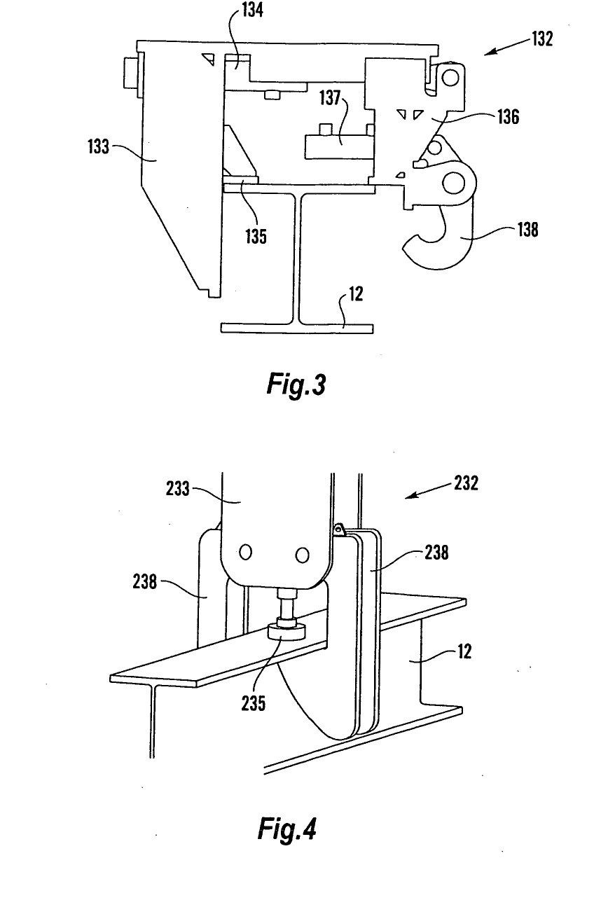

FIG. 3 shows a second embodiment of a clamp according to the invention, which is generally designated 132. The clamp 132 is shown in a pre-engagement position relative to a beam 12. The clamp 132 comprises a housing 133, a locating member 135, a carriage 136 that is acted on by a first hydraulic ram 134, and a clamp arm 138 that is acted on by a second hydraulic ram 137.

The housing 133 includes a vertical locating surface that is brought into abutment with one end of the upper flange of the beam 12, in use, and a locating member 135 that extends from the upper end of that surface and includes a horizontal lower surface that is brought into abutment with the upper surface of the beam 12, in use. The housing 133 further includes an upper member that extends above, and parallel with, the upper surface of the beam 12. The carriage 136 is slidably mounted to the upper member of the housing 133, and is acted upon by the first hydraulic ram 134 which is mounted within the housing 133.

The carriage 136 includes adjacent vertical and horizontal surfaces at its lower end that are brought into abutment with the other side of the upper flange of the beam 12, and the upper surface of the beam 12, respectively, as the first hydraulic ram 134 is retracted and hence the carriage 136 is moved towards the beam 12, in use. The clamp arm 138 is pivotally attached to the carriage 136 at a point near to the upper end of the arm 138, and the upper end of the arm 138 is pivotally attached to the second hydraulic ram 137 which is mounted within the carriage 136.

Before engagement, the first hydraulic ram 134 is extended, and the second hydraulic ram 137 is retracted, such that the clamp 132 can be positioned with the locating member 135 and the horizontal surface of the carriage 136 contacting the upper surface of the beam 12, and the vertical surface of the housing 133 contacting one end of the upper flange of the beam 12. On actuation, the first hydraulic ram 134 is retracted until the vertical surface of the carriage 136 is brought into abutment with the other end of the upper flange of the beam 12 to that engaged by the housing 133, and the second hydraulic ram 137 is then extended until the clamp arm 138 is brought into abutment with the lower surface of the upper flange of the beam 12. In this way, the clamp 132 captivates the upper flange of the beam 12 between the locating member 135, the carriage 136, and the clamp arm 138.

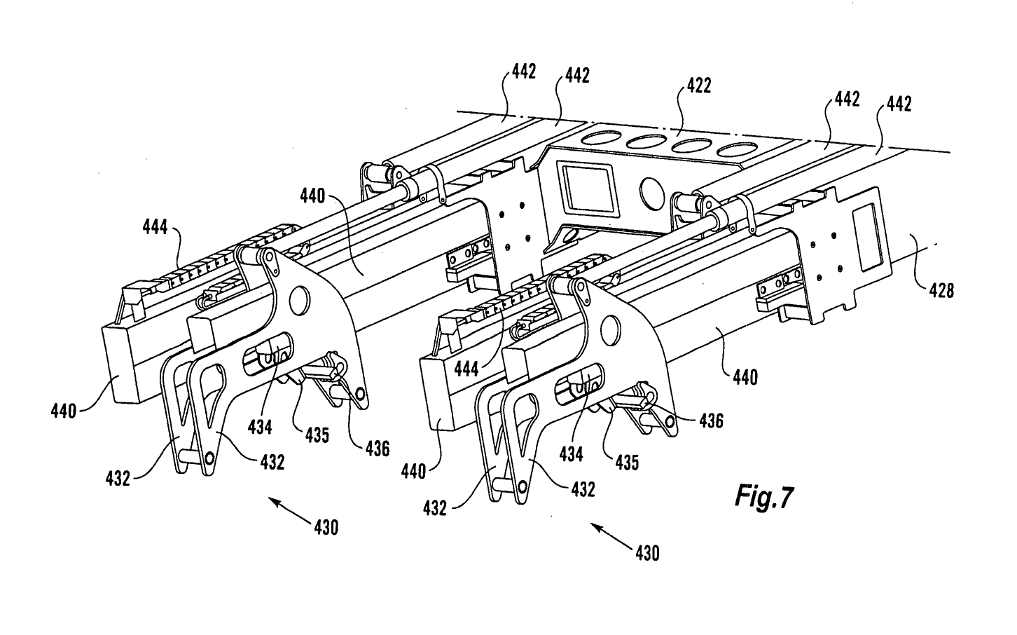

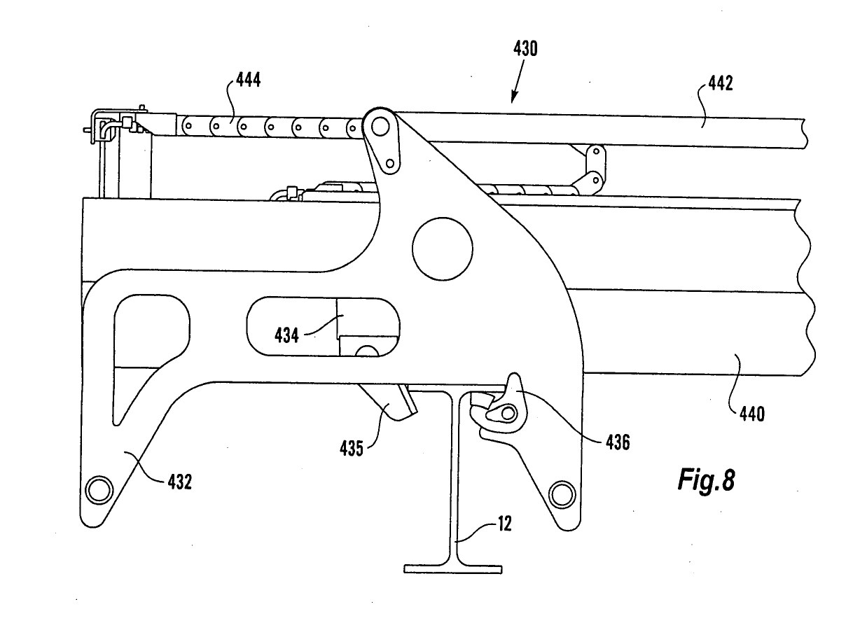

FIG. 4 shows a third embodiment of a clamp according to the invention, which is generally designated 232. The clamp 232 is shown in engagement with a beam 12. The clamp 232 comprises a housing 233, a locating member 235 extending downwardly from the lower end of the housing 233, and a pair of clamp arms 238 that are acted on by a pair of hydraulic rams (not visible in FIG. 7) within the housing 233.

Each clamp arm 238 is pivotally mounted at a point near to its upper end within the housing 233. Hydraulic rams act on the clamp arms 238 so as to cause rotation of the clamp arms 238 into, and out of, engagement with the beam 12. Each clamp arm 238 has a generally channel-shaped cross-section for increased strength.

Before engagement, the clamp arms 238 are positioned so that the clamp 232 can be lowered until the locating member 235 contacts the upper surface of the beam 12. On actuation, the clamp arms 238 are rotated relative to the housing 233 until they are brought into abutment with the lower surface of the upper flange of the beam 12. In this way, the clamp 232 captivates the upper flange of the beam 12 between the locating member 235 and the clamp arms 238.

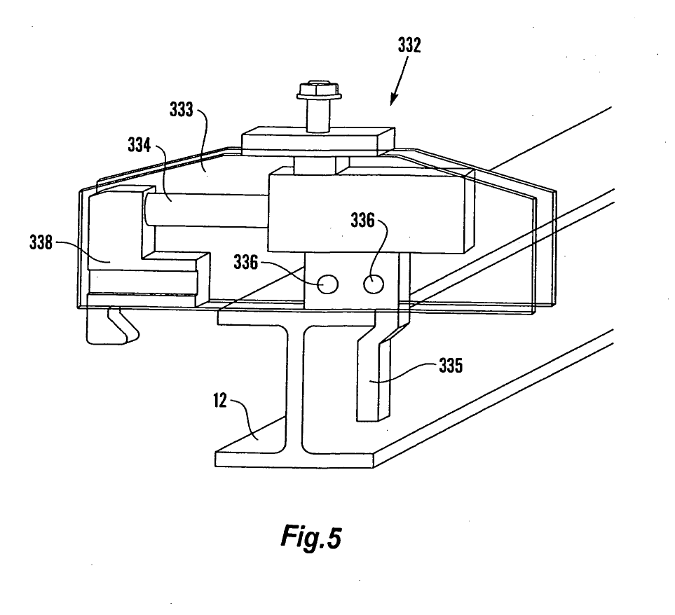

FIG. 5 shows a fourth embodiment of a clamp according to the invention, which is generally designated 332. The clamp 332 is shown in a pre-engagement position relative to a beam 12. The clamp 332 comprises a housing 333, a locating member 335, and a clamp arm 338 that is acted upon by a hydraulic ram 334.

The clamp arm 338 is slidably mounted within the housing 333, and projects downwardly therefrom. The portion of the clamp arm 338 that projects from the housing 333 is formed with an inwardly facing recess that is adapted to receive one end of the upper flange of the beam 12. The hydraulic ram 334 is mounted within the housing 333, and acts to slide the clamp arm 338 relative to the housing 333. The locating member 335 has an upper portion that is slidably mounted within a lower part of the housing 333 and has a lower surface adapted to be brought into abutment with the upper surface of the beam 12, and a projection that extends downwardly from the end of the upper portion that is remote from the clamp arm 338. The projection of the locating member 335 has a vertical surface that is adapted to be brought into abutment with the other end of the upper flange of the beam 12 to that which is to be received by the clamp arm 338.

Before engagement, the locating member 335 is positioned relative to the housing 333 such that the beam 12 will be centrally positioned relative to the clamp 332 when the horizontal and vertical surfaces of the locating member 335 are brought into contact with the upper surface of the beam 12, and one end of the upper flange of the beam 12, respectively. The locating member 335 is secured in this position by a pair of latching pins 336 that are fastened within opposing openings in the housing 333. Once the locating member 335 has been secured in this position, the horizontal and vertical surfaces of the locating member 335 are brought into contact with the upper surface of the beam 12, and one end of the upper flange of the beam 12, respectively. The clamp 332 is then actuated causing the first hydraulic ram 334 to be retracted until the recess of the clamp arm 338 receives the other end of the upper flange of the beam 12 to that engaged by the locating member 335. In this way, the clamp 332 captivates the upper flange of the beam 12 between the locating member 335 and the clamp arm 338. The fourth embodiment 332 is therefore able to engage beams having a large range of widths.

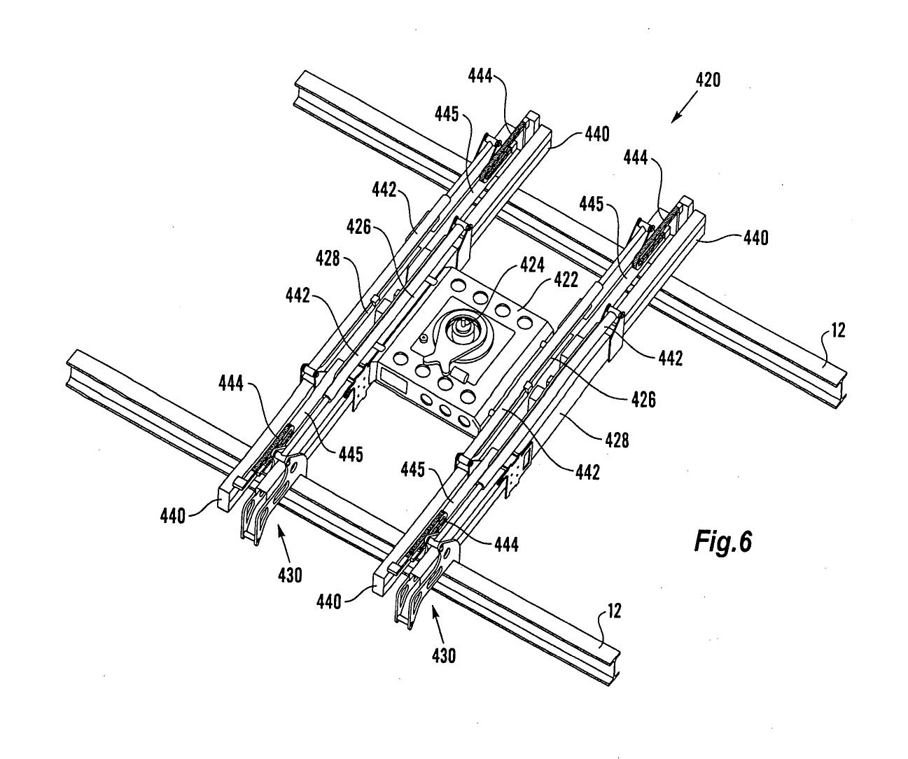

FIG. 6 shows a base unit of apparatus according to the invention, which is generally designated 420, engaged with a pair of parallel beams 12. The base unit 420 comprises a central housing 422 upon which an upper part of the apparatus is mounted. The upper part of the apparatus is rotatably mounted to the central housing 422, and a suitable drive mechanism (not shown in the Figures) are provided for rotating the upper part of the apparatus relative to the base unit 420 during use. In this embodiment, the drive mechanism comprises a ring gear that is mounted to the base unit 420 and cooperates via a bearing system with a worm or gearbox drive that is mounted to the upper part of the apparatus. In addition, connection apparatus 424 for guiding oil and electrical circuits between the upper part of the apparatus and the central housing 422 is also provided.

The central housing 422 includes a pair of parallel side walls to each of which is fixed an inner leg housing 426. The inner leg housings 426 are each generally box-section members that extend parallel to the side walls of the housing 422 to which they are fixed, and extend a little beyond the length of the side walls at each end. Furthermore, identical outer leg housings 428 are mounted adjacent and parallel to the inner leg housings 426.

A leg 440 is mounted within each of the inner and outer leg housings 426,428, such that the base unit 420 comprises four legs 440, two on each side of the central housing 422. Each leg 440 is defined by two channel-section members that are fixed to one another such that the leg 440 is of box-section construction. Each leg 440 is slidably mounted within its associated leg housing 426,428 so as to be movable relative to the leg housing 426,428 along its longitudinal axis. The four legs 440 are therefore at all times parallel to one another during use.

A fifth, and presently preferred, embodiment of a clamp according to the invention, which is generally designated 430 and described in more detail below with reference to FIGS. 7 to 12, is formed at an end of each of the four legs 440, such that the base unit 420 has front and rear ends that each have a pair of clamps 430 (the clamps 430 at the far end of the base unit 420 are hidden) with a pre-determined and constant separation.

Each leg 440 is also provided with an external hydraulic ram 442 that actuates movement of the leg 440 relative to the associated leg housing 446,448. In particular, each external hydraulic ram 442 extends along the upper surface of that leg housing 446,448, and is fixed at one end to an end of a leg housing 446,448, and at its other end to the clamp 430 at the end of the associated leg 440.

A hose- and cable-carrying tray 444 is provided for each leg 440, at the opposite end of the leg 440 from the clamp 430. Each tray 444 extends between the leg 440 and a platform 445 that is fixed to an end of the leg housings 446,448. Hydraulic hoses and cables for the mechanisms and associated sensors of a particular leg 440 extend along the platform 445 and through the tray 444 to that leg 440.

Turning now also to FIGS. 7 and 8, the clamp 430 comprises a pair of mounting plates 432, an inner clamp member 436 and an outer clamp member 435. The mounting plates 432 are fixed to either side of an end portion of the leg 440, and each comprise a pair of lower projections that together define a generally trapezoidal depression for receiving at least a flange of the beam 12 during use. The surfaces of the mounting plates 432 that define this depression include a surface that is orientated parallel to the associated leg 440. This surface defines a location surface of the clamp 430 that is adapted to lie alongside the upper surface (as viewed in FIG. 8) of the beam 12 during use.

The mounting plates 432 also include an upper projection to which is mounted an end of the external hydraulic ram 442. In this way, actuation of the external hydraulic ram 442 effects movement of the leg 440 and mounting plates 432 relative to housings 422,426,428 of the base unit 420.

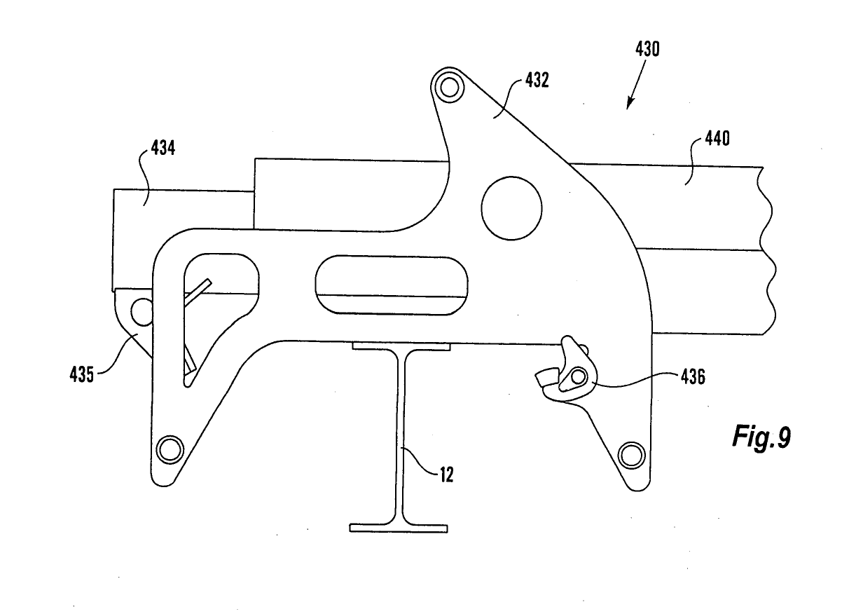

The inner clamp member 436 comprises four mounting arms, two of which are rotatably mounted either side of one mounting plate 432 and two of which are rotatably mounted either side of the adjacent mounting plate 432. The mounting arms are identical to one another in shape, and are arranged in registration with one another. Furthermore, each mounting arm is generally arcuate in form so as to define a concave surface that faces the outer clamp member 435 and is situated adjacent to the location surface of the clamp 430. The portion of the concave surface that is immediately adjacent to the location surface of the clamp 430 is adapted for engagement by the flange of the beam 12, as discussed in more detail below with reference to FIGS. 9 to 12. The inner clamp member 436 further includes an engagement bar that is mounted to the other end of the concave surface, the engagement bar being adapted to engage the underside of the flange of the beam 12.

The outer clamp member 435 is mounted for linear movement relative to the mounting plates 432 and the inner clamp member 436 in a direction that is parallel to the associated leg 440. In particular, the outer clamp member 435 is mounted to an end of a carriage 434 that is slidably mounted within the leg 440. The carriage 434 has the form of a box-section member, and is aligned along a generally central longitudinal axis of the leg 440. An inner hydraulic ram is mounted within the interior of the leg 440, and acts to effect movement of the carriage 434, and hence the outer clamp member 435, relative to the remainder of the clamp 430.

The outer clamp member 435 comprises an engagement surface that is inclined relative to the location surface of the clamp 430 so as to define an recess therebetween. Furthermore, this recess faces the inner clamp member 436. As shown most clearly in FIG. 7, the upper channel-section member of each leg 440 extends a greater distance than the lower channel-section member, such that the outer clamp member 435 projects from the underside of the leg 440 into the depression defined by the mounting plates 432, and the outer clamp member 435 is able to move along almost the entire extent of the location surface of the clamp 430.

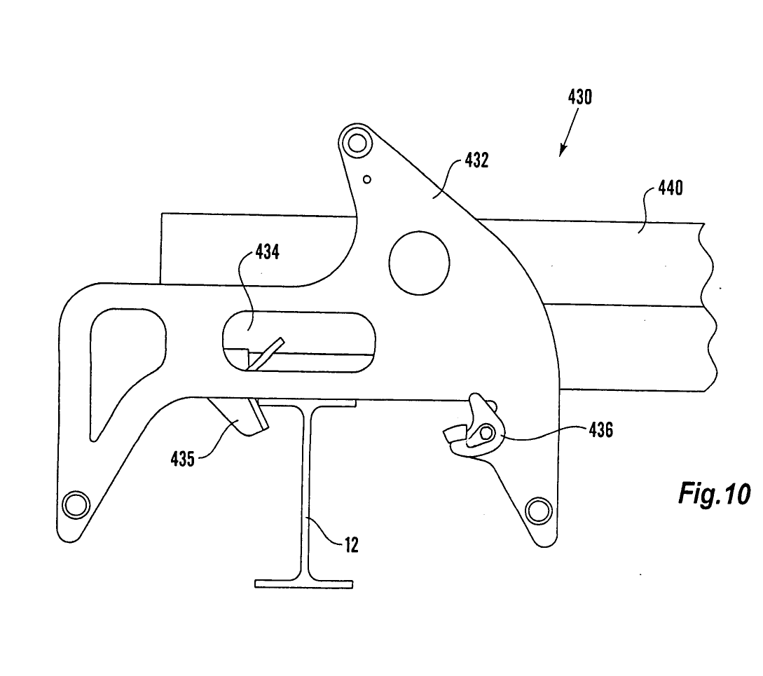

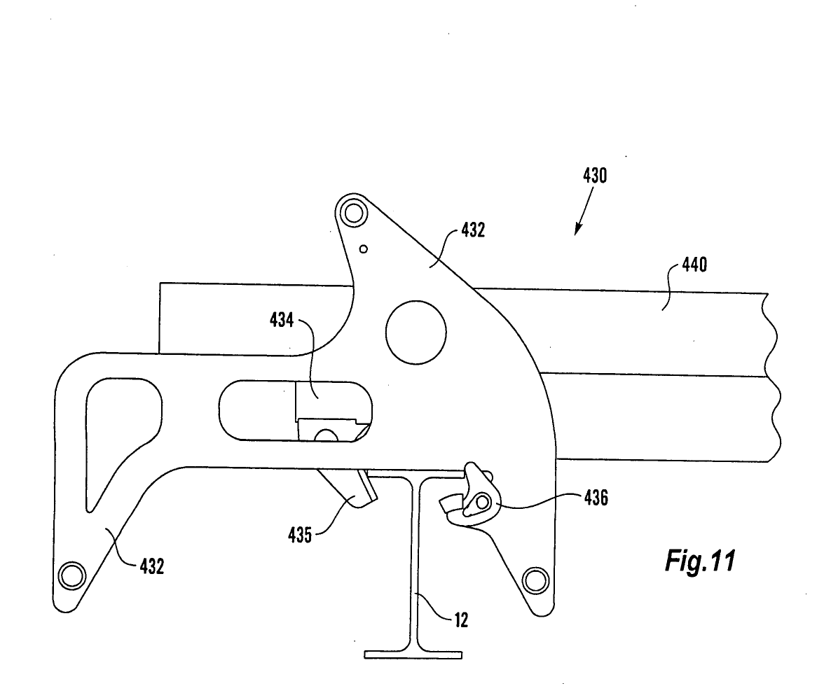

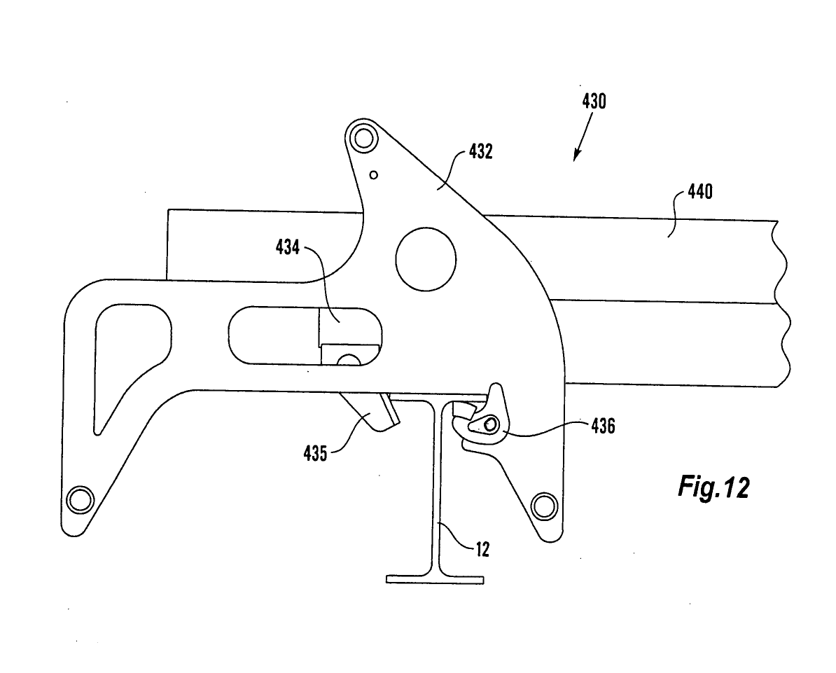

FIG. 9 to 12 illustrate engagement of the clamp 430 with an I-section beam 12. In FIG. 9, the carriage 434 is fully extended from the leg 440 so that the outer clamp member 435 does not extend into the depression defined by the mounting plates 432. In use, the clamp 430 is lowered until the location surface rests upon the upper surface of the beam 12, as shown in FIG. 9. The carriage 434 is then retracted until the engagement surface of the outer clamp member 435 engages a peripheral part of the underside of the flange of the beam 12, as shown in FIG. 10. The leg 440 is then extended, whilst at the same time retracting the carriage 434 so that the outer clamp member 435 remains engaged with the beam 12, until the flange of the beam 12 engages the portion of the concave surface of the inner clamp member 436 that is immediately adjacent to the location surface, as shown in FIG. 11, and causes the inner clamp member 436 to rotate until the engagement bar of the inner clamp member 436 engages the underside of the flange, as shown in FIG. 12.

In use, apparatus including the base unit 420 of FIG. 7 is lifted using a tower crane or the like and suspended above two parallel horizontal beams 12 of a structure. The apparatus is suspended from the upper part of the apparatus (not shown in the Figures), such that the base unit 420 of the apparatus may be rotated relative to the beams 12. The base unit 420 is rotated until the legs 440 are orientated perpendicularly to the two parallel beams 12. The legs 440 are then extended or retracted until the clamps 430 are appropriately positioned to engage with the two parallel horizontal beams 12. The apparatus is then lowered until the location surface of the each clamp 430 lies alongside the upper surface of each beam 12. The clamps 430 are then actuated, as described above, so as to secure the apparatus to the structure.

1. A clamp for engagement with an object, the clamp comprising a location surface adapted to lie against an external surface of the object, and first and second clamp members adapted for movement relative to one another, wherein the first and second clamp members are adapted to be brought into engagement with the object, such that the object or part of the object is captivated, in use, between the location surface and the first and second clamp members.

2. A clamp as claimed in claim 1, wherein the clamp is adapted for engagement with a beam.

3. A clamp as claimed in claim 2, wherein the clamp is adapted for engagement with an I-section beam comprising a pair of flanges joined by a connecting web.

4. A clamp as claimed in claim 3, wherein the location surface is adapted to lie against an outer face of one of the two flanges, and the clamp members are adapted to engage an inner face of that flange on either side of the connecting web, such that the flange is captivated, in use, between the location surface and the first and second clamp members.

5. A clamp as claimed in claim 1, wherein the clamp comprises a housing to which the first and second clamp members are mounted.

6. A clamp as claimed in claim 5, wherein the location surface is defined by the housing.

7. A clamp as claimed in claim 1, wherein the clamp includes a depression within which the object or part of the object is received, in use, as the location surface is brought alongside an external surface of the object.

8. A clamp as claimed in claim 7, wherein the depression is defined by either the housing alone, or the housing together with one or both of the clamp members.

9. A clamp as claimed in claim 8, wherein the depression is defined substantially by the housing, and is tapered so as to aid location of the flange alongside the location surface.

10. A clamp as claimed in claim 1, wherein one or both of the first and second clamp members is rotatably mounted relative to the location surface, such that the clamp members may be brought into engagement with the object once the location surface has been located alongside an external surface of the object.

11. A clamp as claimed in claim 1, wherein the first clamp member is mounted for linear movement relative to the second clamp member.

12. A clamp as claimed in claim 11, wherein the first clamp member is mounted for linear movement relative to the second clamp member, the housing and the location surface.

13. A clamp as claimed in claim 12, wherein the first clamp member is mounted for linear movement in the plane of the location surface.

14. A clamp as claimed in claim 11, wherein the linear movement is actuated by a hydraulic ram or the like.

15. A clamp as claimed in claim 11, wherein the first clamp member and/or the second clamp member has an operable face that is inclined relative to the operable face of the location surface, such that the operable face of the first clamp member or the second clamp member and the operable face of the location surface subtend an acute angle.

16. A clamp as claimed in claim 11, wherein the first clamp member and/or the second clamp member is rotatable relative to the location surface so that the clamp member may be rotated into engagement with an external surface of the object.

17. A clamp as claimed in claim 16, wherein said rotation is effected by the object impinging upon the clamp member during use.

18. A clamp as claimed in claim 16, wherein the first clamp member has an inclined operable face, and the second clamp member is rotatable relative to the location surface.

19. Construction apparatus comprising one or more clamps wherein each of the one or more clamps comprises a location surface adapted to lie against an external surface of the object, and first and second clamp members adapted for movement relative to one another, wherein the first and second clamp members are adapted to be brought into engagement with the object, such that the object or part of the object is captivated, in use, between the location surface and the first and second clamp members.

20. Construction apparatus as claimed in claim 19, wherein the apparatus comprises a base unit including a plurality of said clamps for fixing the base unit to a structure such that the base unit is in an elevated position relative to the ground.

21. Construction apparatus as claimed in claim 20, wherein one or more of said clamps are movably mounted relative to the base unit.

22. Construction apparatus as claimed in claim 21, wherein the clamps of the apparatus are adapted to engage a pair of horizontal beams that are orientated parallel to each other.

23. Construction apparatus as claimed in claim 19, wherein each clamp is attached to a leg that extends from the base unit.

24. Construction apparatus as claimed in claim 23, wherein each leg is movable relative to the base unit and/or adjustable in length such that the length of that part of the leg that projects beyond the base unit is alterable.

25. Construction apparatus as claimed in claim 24, wherein each leg is slidably mounted within a housing that is fixed relative to the base unit, such that a clamp at one end of each leg may be extended and retracted relative to the base unit by movement of the leg relative to the housing.

26. Construction apparatus as claimed in claim 19, wherein operation of the clamps and/or movement of the clamps relative to the base unit is controllable by a construction worker accommodated by the apparatus.

27. Construction apparatus as claimed in 19, wherein each clamp is fixed to one end of a leg of the base unit, and the first clamp member is mounted to a carriage, which is itself mounted within the leg and includes a mechanism for moving the carriage relative to the leg, such that the first clamp member may be moved along a linear path relative to the leg.

28. Construction apparatus as claimed in claim 27, wherein the carriage is slidably mounted within the leg.

29. Construction apparatus as claimed in claim 27, wherein the second clamp member has a fixed linear position relative to the leg.
